(19) United States
(12) Patent Application Publication
(10) Pub. No.: US 2023/0384436 A1
(43) Pub. Date: Nov. 30, 2023

(54) DISTANCE MEASUREMENT CORRECTION DEVICE, DISTANCE MEASUREMENT CORRECTION METHOD, AND DISTANCE MEASUREMENT DEVICE

(71) Applicant: DENSO CORPORATION, Kariya-city (JP)

(72) Inventor: TOMONARI YOSHIDA, Kariya-city (JP)

(21) Appl. No.: 18/450,299

(22) Filed: Aug. 15, 2023

Related U.S. Application Data
(63) Continuation of application No. PCT/JP2022/004730, filed on Feb. 7, 2022.

(30) Foreign Application Priority Data
Feb. 17, 2021 (JP) 2021-023679
Jan. 13, 2022 (JP) 2022-003820

(51) Int. Cl. G01S 7/497; G01C 3/08; G01S 17/931; G01S 17/10

(52) U.S. Cl. CPC G01S 7/497; G01C 3/08; G01S 17/931; G01S 17/10

(57) ABSTRACT

A distance measurement correction device acquires, for each reflection point on a target, acquires relevant information, which is information related to a distance detected with respect to a pixel corresponding to the reflection point. The device calculates an inclination feature amount related to an inclination magnitude of each partial surface of the target relative to a reference surface, each partial surface of the target including each reflection point, respectively. The device corrects the distance to each reflection point based on the corresponding inclination feature amount.

### CROSS REFERENCE TO RELATED APPLICATIONS

The present application is a continuation application of International Patent Application No. PCT/JP2022/004730 filed on Feb. 7, 2022, which designated the U.S. and claims the benefit of priority from Japanese Patent Application No. 2021-023679 filed on Feb. 17, 2021 and Japanese Patent Application No. 2022-003820 filed on Jan. 13, 2022. The entire disclosures of all of the above applications are incorporated herein by reference.

### TECHNICAL FIELD

The present disclosure relates to a technique for measuring a distance to a reflection point by detecting reflected light from the reflection point with respect to irradiated light.

### BACKGROUND

Conventionally, a distance measurement device that corrects a measurement result is known. This device measures a quantity of photons received by a light receiving unit, and corrects a walk error caused by an intensity of received light based on the quantity of photons.

### SUMMARY

The present disclosure provides a distance measurement correction device. For each reflection point on a target, the device acquires relevant information, which is information related to a distance detected with respect to a pixel corresponding to the reflection point. The device calculates an inclination feature amount related to an inclination magnitude of each partial surface of the target relative to a reference surface, each partial surface of the target including each reflection point, respectively. The device corrects the distance to each reflection point based on the corresponding inclination feature amount.

### BRIEF DESCRIPTION OF DRAWINGS

Objects, features and advantages of the present disclosure will become apparent from the following detailed description made with reference to the accompanying drawings. In the drawings:

FIG. 1 is a block diagram illustrating an example of functions of a distance measurement correction device;

FIG. 2 is a diagram conceptually illustrating a change in a detected waveform corresponding to an inclination;

FIG. 3 is a diagram conceptually illustrating a calculation method of normal vector;

FIG. 4 is a flowchart illustrating an example of a distance measurement correction method executed by the distance measurement correction device;

FIG. 5 is a diagram conceptually illustrating a calculation method of normal vector according to a second embodiment;

FIG. 6 is a flowchart illustrating an example of a distance measurement correction method executed by a distance measurement correction device according to the second embodiment;

FIG. 7 is a block diagram illustrating an example of functions of a distance measurement correction device according to a third embodiment;

FIG. 8 is a diagram illustrating a feature amount of a waveform;

FIG. 9 is a flowchart illustrating an example of a distance measurement correction method executed by the distance measurement correction device according to the third embodiment;

FIG. 10 is a block diagram illustrating an example of functions of a distance measurement correction device according to a fourth embodiment;

FIG. 11 is a flowchart illustrating an example of a distance measurement correction method executed by the distance measurement correction device according to the fourth embodiment;

FIG. 12 is a block diagram illustrating an example of functions of a distance measurement correction device according to a fifth embodiment;

FIG. 13 is a diagram conceptually illustrating setting of scan speed according to the fifth embodiment;

FIG. 14 is a flowchart illustrating an example of a distance measurement correction method executed by the distance measurement correction device according to the fifth embodiment; and

FIG. 15 is a diagram conceptually illustrating setting of scan speed according to a sixth embodiment.

### DETAILED DESCRIPTION

Conventionally, a device that corrects a measurement result of a measurement device is known. This kind of device measures a quantity of photons received by a light receiving unit, and corrects a walk error caused by an intensity of received light based on the quantity of photons.

In a distance measurement device that detects reflected light, a detection error of a distance may occur due to an inclination of a reflection surface. In the above-described device, it is difficult to correct an error caused by the inclination of the reflection surface.

According to an aspect of the present disclosure, a distance measurement correction device, which corrects a distance measurement result output from a distance measurement device, is provided. The distance measurement device measures a distance to a reflection point on a target by detecting, as a pixel, light reflected on the reflection point in response to irradiation of the light. The distance measurement correction device includes a processor that is configured to: for each of a plurality of reflection points, acquire relevant information, which is information related to a distance detected with respect to a pixel corresponding to each of the plurality of reflection points; calculate an inclination feature amount related to an inclination magnitude of each of a plurality of partial surfaces of the target relative to a reference surface, the plurality of partial surfaces of the target including the plurality of reflection points, respectively; and correct the distance to each of the plurality of reflection points based on the corresponding inclination feature amount.

According to another aspect of the present disclosure, a distance measurement correction method, which corrects a distance measurement result output from a distance measurement device, is provided. The distance measurement device measures a distance to a reflection point on a target by detecting, as a pixel, light reflected on the reflection point in response to irradiation of the light. The distance measurement correction method is executed by a processor and includes: for each of a plurality of reflection points, acquiring relevant information, which is information related to a distance detected with respect to a pixel corresponding to each of the plurality of reflection points; calculating an inclination feature amount related to an inclination magnitude of each of a plurality of partial surfaces of the target relative to a reference surface, the plurality of partial surfaces of the target including the plurality of reflection points, respectively; and correcting the distance to each of the plurality of reflection points based on the corresponding inclination feature amount.

According to another aspect of the present disclosure, a computer-readable non-transitory storage medium, which stores a program comprising instructions to be executed by a processor, is provided. When being executed by the processor, the program corrects a distance measurement result output from a distance measurement device. The distance measurement device measures a distance to a reflection point on a target by detecting, as a pixel, light reflected on the reflection point in response to irradiation of the light. The instructions include: for each of a plurality of reflection points, acquiring relevant information, which is information related to a distance detected with respect to a pixel corresponding to each of the plurality of reflection points; calculating an inclination feature amount related to an inclination magnitude of each of a plurality of partial surfaces of the target relative to a reference surface, the plurality of partial surfaces of the target including the plurality of reflection points, respectively; and correcting the distance to each of the plurality of reflection points based on the corresponding inclination feature amount.

According to another aspect of the present disclosure, a distance measurement device measures a distance to a reflection point on a target by detecting, as a pixel, light reflected on the reflection point in response to irradiation of the light. The distance measurement device comprising a processor, which is configured to: for each of a plurality of reflection points, acquire relevant information, which is information related to a distance detected with respect to a pixel corresponding to each of the plurality of reflection points; calculate an inclination feature amount related to an inclination magnitude of each of a plurality of partial surfaces of the target relative to a reference surface, the plurality of partial surfaces of the target including the plurality of reflection points, respectively; and correct the distance to each of the plurality of reflection points based on the corresponding inclination feature amount.

According to above configurations, the distance to each reflection point is corrected based on the inclination feature amount of corresponding reflection point. Thus, an error caused by the inclination of partial surface constituting the reflection point can be corrected. Thus, a distance measurement correction device, a distance measurement correction method, and a distance measurement correction program according to the present disclosure can improve distance measurement accuracy.

### First Embodiment

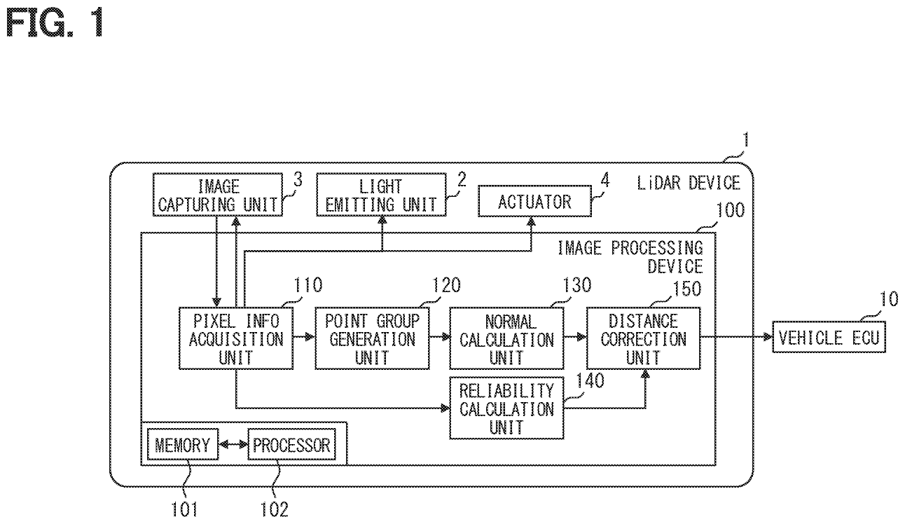

As illustrated in FIG. 1, an image processing device 100, which corresponds to a distance measurement correction device according to an embodiment of the present disclosure, is equipped to a Light Detection and Ranging/Laser Imaging Detection and Ranging (LiDAR) device 1. The LiDAR device 1 is a distance measurement device that measures a distance to a reflection point by detecting light reflected from the reflection point in response to irradiation of light to the reflection point. The LiDAR device 1 is, for example, a sensor mounted on a vehicle having at least one of an advanced driving support function or an autonomous driving function. The LiDAR device 1 is communicably connected to a vehicle ECU 10. The vehicle ECU 10 is an electronic control device, and uses the measurement result of the LiDAR device 1 in a processing.

The LiDAR device 1 includes a light emitting unit 2 and an image capturing unit 3, in addition to the image processing device 100.

The light emitting unit 2 is a semiconductor element that emits directional laser light, such as a laser diode. The light emitting unit 2 emits laser light toward an outside of the vehicle in a form of intermittent pulse beam. The image capturing unit 3 includes a light receiving element having high light sensitivity, such as a single photon avalanche diode (SPAD). The image capturing unit 3 is exposed to light incident from a sensing region determined by an image capturing angle of the image capturing unit 3 out of an external region of the image capturing unit 3. The image capturing unit 3 may include multiple light receiving elements, and the multiple light receiving elements may be arrayed in a two-dimensional direction, for example. A pixel in reflected light detection is configured by a set of adjacent light receiving elements. That is, information indicating a relationship between a distance to the reflection point and reflection intensity, which will be described later, is detected for each pixel configured by a set of light receiving elements.

An actuator 4 controls a reflection angle of a reflection mirror that reflects the laser light emitted from the light emitting unit 2 to an emission surface of the LiDAR device 1. Scanning by the laser beam is implemented controlling the reflection angle of the reflection mirror by the actuator 4. The scanning direction may be a horizontal direction or a vertical direction. The actuator 4 may scan the laser beam by controlling an attitude angle of a housing of the LiDAR device 1.

The image processing device 100 is provided by a computer including at least one memory 101 and at least one processor 102. The memory 101 is at least one type of non-transitory tangible storage medium such as a semiconductor memory, a magnetic medium, and an optical medium that stores a computer-readable program and data in non-transitory manner. The memory 101 stores various programs to be executed by the processor 102, such as a distance correction program to be described later.

The processor 102 includes, for example, at least one of a central processing unit (CPU), a graphics processing unit (GPU), a reduced instruction set computer (RISC)-CPU, and the like as a core. The processor 102 executes instructions included in a distance measurement correction program stored in the memory 101. By executing the instructions of programs, the image processing device 100 functions as multiple functional units that perform correction processing of distance measurement result, that is, the distance to the target T measured based on the detection information of the image capturing unit 3. As described above, in the image processing device 100, the processor 102 functions as the functional units by executing instructions of the distance measurement correction program stored in the memory 101. Specifically, as illustrated in FIG. 1, the image processing device 100 includes, as functional units, a pixel information acquisition unit 110, a point group generation unit 120, a normal calculation unit 130, a reliability calculation unit 140, and a distance correction unit 150.

The pixel information acquisition unit 110 controls exposure and scanning of pixels by the image capturing unit 3, and processes signals from the image capturing unit 3 into data. In a reflected light mode in which the pixel information acquisition unit 110 exposes the image capturing unit 3 to irradiation of light emitted from the light emitting unit 2, an object point in the sensing region corresponds to a reflection point of the laser light. As a result, the laser light reflected at the reflection point (hereinafter, referred to as reflected light) is incident on the image capturing unit 3 through an incidence surface. The pixel information acquisition unit 110 senses the reflected light beams by scanning multiple pixels of the image capturing unit 3.

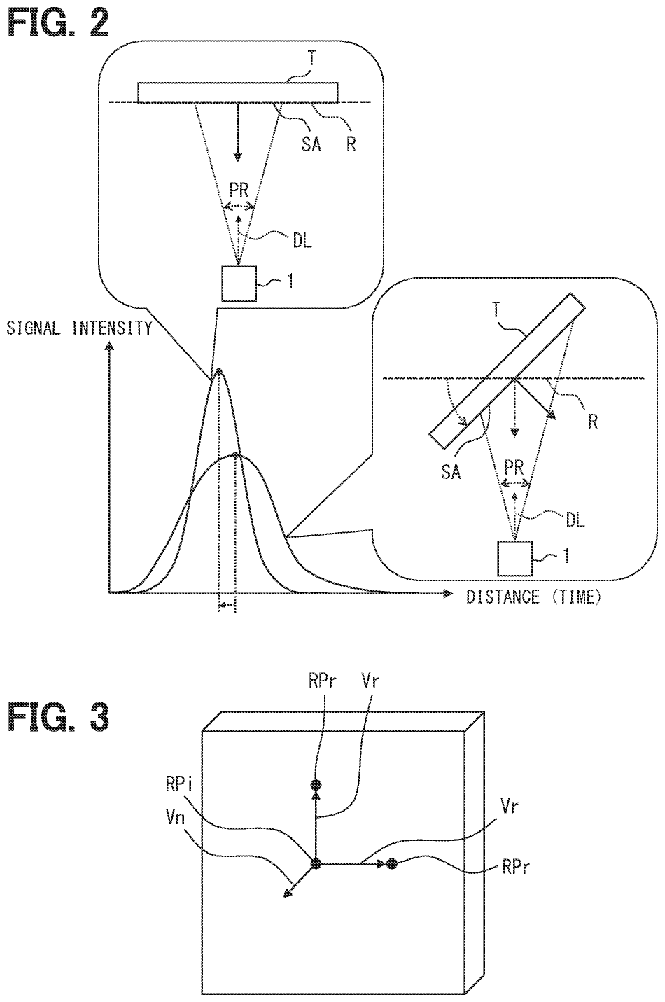

The pixel information acquisition unit 110 integrates the reflection intensity scanned in each pixel for each light receiving frequency. Accordingly, as illustrated in FIG. 2 and the like, the pixel information acquisition unit 110 acquires, for each pixel, the relationship between the reflection intensity and the distance to the reflection point, as information related to the distance to the reflection point (hereinafter referred to as relevant information). The distance to the reflection corresponds to duration from emitting of the light to the detection of the reflected light. Specifically, the pixel information acquisition unit 110 may acquire the relationship information as histogram information obtained by integrating the reflection intensity for each predetermined distance bin or waveform information based on the reflection intensity for each distance bin in the histogram. In the present embodiment, an example in which the relationship information is provided by the waveform information as illustrated in FIG. 2 will be described. The pixel information acquisition unit 110 acquires pixel information including information related to the distance to the reflection point. On the target T, a partial surface SA, which reflects light beams to be incident on the same pixel, constitutes a reflection point detected by the pixel. The pixel information acquisition unit 110 can acquire, as a distance image, two-dimensional data including such pixel information for each pixel.

In an external light mode, the pixel information acquisition unit 110 exposes the image capturing unit 3 under a state where intermittent light irradiation from the light emitting unit 2 is stopped. In this mode, an object point included in the sensing region corresponds to a reflection point of external light. As a result, the external light reflected by the reflection point enters the image capturing unit 3 through the incidence surface. At this time, the pixel information acquisition unit 110 senses the reflected external light by scanning pixels of the image capturing unit 3. In particular, the pixel information acquisition unit 110 can acquire the external light image by converting a luminance value acquired for each pixel according to the intensity of the sensed external light into two-dimensional data as each pixel value. The external light image may also be referred to as a background light image or a disturbance light image.

The pixel information acquisition unit 110 determines whether the waveform information (detected waveform information) of the detected reflected wave is valid for the newly acquired pixel information. For example, the pixel information acquisition unit 110 may determine whether the detected waveform information is valid based on a magnitude of the S/N ratio of the waveform, an amplitude of the waveform, or the like. When it is determined that the detected waveform information is not valid, the pixel information acquisition unit 110 rejects the acquired pixel information. The pixel information acquisition unit 110 acquires pixel information for all pixels in each control cycle. The pixel information acquisition unit 110 sequentially provides, to the point group generation unit 120, the acquired pixel information corresponding to each pixel.

The pixel information acquisition unit 110 removes noise from the generated distance image. For example, the pixel information acquisition unit 110 determines, based on a past distance image, a region to which a noise removal filter is to be applied in a current distance image. More specifically, the pixel information acquisition unit 110 divides a frame of the distance image into a non-existence region and an existence region. In the non-existence region, a point group does not exist. In the existence region, a point group exists at the same position as in the past distance image (for example, one frame before the current distance image). The point group generation unit 120 skips the application of the noise removal filter to the non-existence region. The pixel information acquisition unit 110 applies the noise removal filter to the existence region. The noise removal filter has different parameters depending on the types of the objects, and the noise removal filter having the proper parameter is selected corresponding to the type of the target object. For example, the pixel information acquisition unit 110 changes the parameter of noise removal filter for an object having a relatively large number of substantially flat portions and an object having a small number of substantially flat portions. The object having a relatively large number of flat portions is, for example, a road, a building, or the like. The object having a relatively small number of flat portions is a person, an animal, or the like. The pixel information acquisition unit 110 may set the existence region to be larger than an actual region where the object actually exists, with consideration of a motion of the object.

The point group generation unit 120 converts the distance value to the reflection point included in the acquired pixel information into three-dimensional coordinate information. The point group generation unit 120 may convert the distance value into a three-dimensional coordinate value in the LiDAR coordinate system centered on the LiDAR device 1 based on a focal length of the optical system, the number of pixels of the image sensor, the size of the image capturing sensor, and the like. The point group generation unit 120 converts all distance values into three-dimensional coordinate values of the three-dimensional coordinate system, and generates point group data including coordinate information of the reflection point corresponding to each pixel.

The normal calculation unit 130 calculates the normal direction of the reflection point as an inclination feature amount. The inclination feature amount is a parameter related to an inclination magnitude of the partial surface SA of the target T constituting the reflection point with respect to a reference surface R. The reference surface R is a virtual surface that faces the line-of-sight direction DL of each pixel in the LiDAR device 1 described later. The normal calculation unit 130 calculates the normal direction of each reflection point based on the three-dimensional position information of the point group data. Specifically, the normal calculation unit 130 calculates a normal vector Vn including information on the normal direction. For example, the normal calculation unit 130 sets, as the normal vector Vn, an outer product of two vectors (reference vectors) based on reflection points corresponding to pixels.

More specifically, as illustrated in FIG. 3, the normal calculation unit 130 sets, as a start point of a reference vector Vr, the reflection point (reflection point of interest) RPi for which the normal vector Vn is calculated. Then, the normal calculation unit 130 selects two reflection points (reference reflection points) RPr located in the vicinity of the reflection point of interest RPi. For example, the reference reflection points RPr may be reflection points detected in two pixels adjacent to the pixel corresponding to the reflection point of interest RPi. The normal calculation unit 130 sets, for each reference reflection point, the reference vector Vr having the reflection point of interest RPi as the start point and the reference reflection point RPr as an end point. The normal calculation unit 130 calculates the outer product vector of the reference vectors Vr as the normal vector Vn of the reflection point RPi of interest. The normal calculation unit 130 calculates the normal vector Vn for substantially all reflection points in one frame. The normal calculation unit 130 sequentially provides information of the calculated normal vector Vn to the distance correction unit 150. The normal calculation unit 130 corresponds to an example of a feature amount calculation unit.

The reliability calculation unit 140 calculates a reliability of the normal vector Vn of each reflection point. In the following description, the reliability of normal vector is referred to as normal reliability. The normal reliability is an estimated value related to a magnitude of error of the calculated normal vector Vn. With an increase of the normal reliability, the error of normal vector Vn is reduced. For example, the reliability calculation unit 140 estimates the normal reliability based on at least one of the signal light intensity and the external light intensity, which are included in the detected waveform information detected by the corresponding pixel. With an increase of the signal light intensity, the normal reliability is increased. With an increase of the external light intensity, the normal reliability is reduced. The normal reliability is an example of a calculation reliability.

The distance correction unit 150 corrects the distance value to each reflection point based on the normal vector Vn. For example, the distance correction unit 150 calculates the corrected distance value based on the normal vector Vn, the line-of-sight information of the LiDAR device 1, the distance value before correction, and the normal reliability.

The line-of-sight information of the LiDAR device 1 is information related to the line-of-sight direction DL of the pixel of the LiDAR device 1 in each reflection point detection. The line-of-sight direction DL is, for example, a direction facing the light receiving direction of the reflected light. As indicated by a dotted arrow in FIG. 2, the line-of-sight direction DL is a direction directed to the center of the detection range PR detected by the pixel from the pixel center or the pixel position when the pixel is regarded as a point. The line-of-detection direction DL is a direction in which the center of view angle of corresponding pixel is directed from the pixel center or the pixel position when the pixel is regarded as a point.

On the target T, a partial surface SA, which reflects light beams to be incident on the same pixel, constitutes a reflection point detected by the pixel. In FIG. 2, the partial surface SA is included in the detection range PR on the surface of the target T. As the inclination of the partial surface SA with respect to the reference surface R increases, an optical path length difference of the reflected light on the partial surface increases. The peak of the waveform of the reflection intensity also decreases with an increase of the inclination. Thus, with the increase of the inclination, the waveform may be broadened. With the increase of the inclination, the signal intensity of the peak of the waveform decreases, and the light reception time may be delayed. Therefore, the corrected distance value closer to the true value can be calculated by calculating the correction amount for correcting the distance value in a direction in which the delay of the light reception time, that is, the increase in the length of the distance value is eliminated. In the example illustrated in FIG. 2, the direction in which the increase in the length of the distance value is eliminated is the direction indicated by the dotted arrow in the graph of FIG. 2. In the present embodiment, the partial surface SA is treated as a substantially flat surface.

The distance correction unit 150 increases the correction amount as the relative inclination of the normal vector Vn with respect to the line-of-sight direction DL increases. The distance correction unit 150 increases the correction amount as the distance value before correction increases. The distance correction unit 150 increases the correction with a decrease of the normal reliability. The distance correction unit 150 comprehensively determines the correction amount based on the above parameters. The distance correction unit 150 corrects the distance value based on the determined correction amount. The distance correction unit 150 corrects the distance values for all of the reflection points for which the normal vector Vn have been calculated, and generates a distance image based on the corrected distance values. The distance correction unit 150 provides the generated distance image to another vehicle ECU 10. The distance correction unit 150 may generate point group data by converting the distance image into a three-dimensional point group and provide the generated point group data to the vehicle ECU 10.

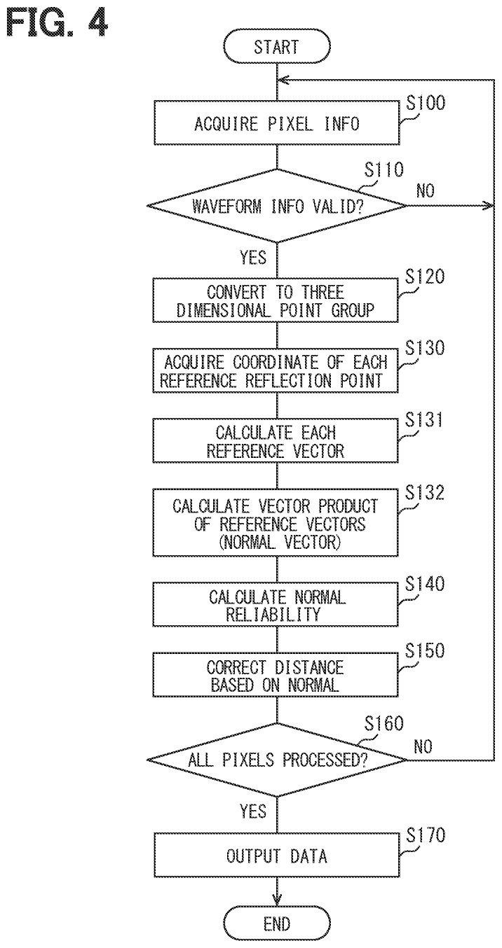

The following will describe a distance measurement correction method executed by the image processing device 100 in cooperation with the functional blocks with reference to FIG. 4. In a flowchart to be described later, “S” indicates one or more steps of the flowchart to be executed by one or more instructions included in the program.

In S100, the pixel information acquisition unit 110 acquires, from the image sensor, new pixel information that are not yet acquired by the pixel information acquisition unit. In S110, the pixel information acquisition unit 110 determines whether the waveform data of pixel information is valid. When it is determined that the waveform data is not valid, the flow returns to S100, and pixel information, which is not yet acquired, is acquired. When it is determined that the waveform data is valid, the flow proceeds to S120.

In S120, the point group generation unit 120 converts the pixel information determined to be valid into three-dimensional coordinate data. In S130, the point group generation unit 120 acquires the coordinates of the reference reflection points RPr in the vicinity of the reflection point of interest RPi. In S131, two reference vectors Vr are calculated based on the two target reflection points RPi and the reference reflection point RPr. In subsequent S132, a normal vector Vn is calculated by calculating an outer product of the two reference vectors Vr.

In S140, the normal calculation unit 130 calculates the normal reliability. In S150, the distance correction unit 150 corrects the distance to the reflection point based on the inclination of the normal vector Vn with respect to the line-of-sight direction DL, the distance to the reflection point, and the magnitude of the normal reliability. In subsequent S160, the distance correction unit 150 determines whether correction has been executed for all of the pixels in the current control cycle. When it is determined that the correction has been executed for all of the pixels, the distance correction unit 150 outputs distance image data in S170.

The process executed in S100 and S110 described above corresponds to an example of a pixel information acquisition process. The process executed in S120 described above corresponds to an example of a point group generation process. The process executed in S130, S131, and S132 described above corresponds to an example of a feature amount calculation process. The process executed in S140 described above corresponds to an example of a reliability calculation process. The process executed in S150, S160, and S170 described above corresponds to an example of a correction process.

According to the first embodiment described above, the distance to each reflection point is corrected based on the normal vector Vn of each reflection point. Thus, an error caused by the inclination of the reflection surface can be corrected. As a result, the distance measurement accuracy can be improved.

According to the first embodiment, the normal vector Vn is calculated by the outer product based on the position information of the target reflection point RPi and multiple reference reflection points RPr. According to this configuration, the inclination of the normal is obtained by the vector calculation. Thus, the inclination of the normal can be calculated at a relatively high speed.

According to the first embodiment, the correction amount of the normal vector Vn of the reflection point of interest RPi increases as increase of inclination magnitude of the normal vector Vn of the reflection point of interest RPi with respect to the line-of-sight direction DL in the corresponding pixel. Therefore, in a case where the deviation from the true value is likely to be large and the inclination of the reflection point is large, the distance can be corrected more largely. Therefore, the distance can be corrected more accurately.

According to the first embodiment, the correction amount increases with an increase of the calculation reliability of the normal vector Vn. According to this configuration, with an increase of the reliability of the normal vector Vn, the correction amount corresponding to the inclination of the normal vector Vn is increased. Therefore, the distance can be corrected more accurately.

According to the first embodiment, the correction amount increases with increase of the uncorrected distance to the target reflection point RPi. As the distance to the reflection point of interest RPi increases, the difference in the optical path length in one pixel to the reflection point increases, and thus the deviation of the distance from the true value is likely to increase. Therefore, as the distance before correction increases, the distance can be corrected more accurately by increasing the correction amount.

### Second Embodiment

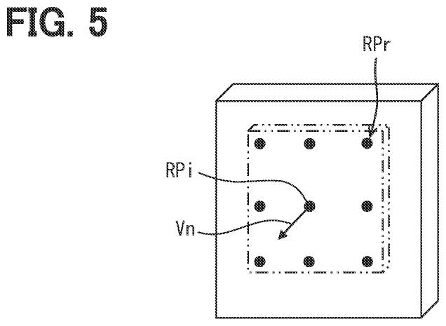

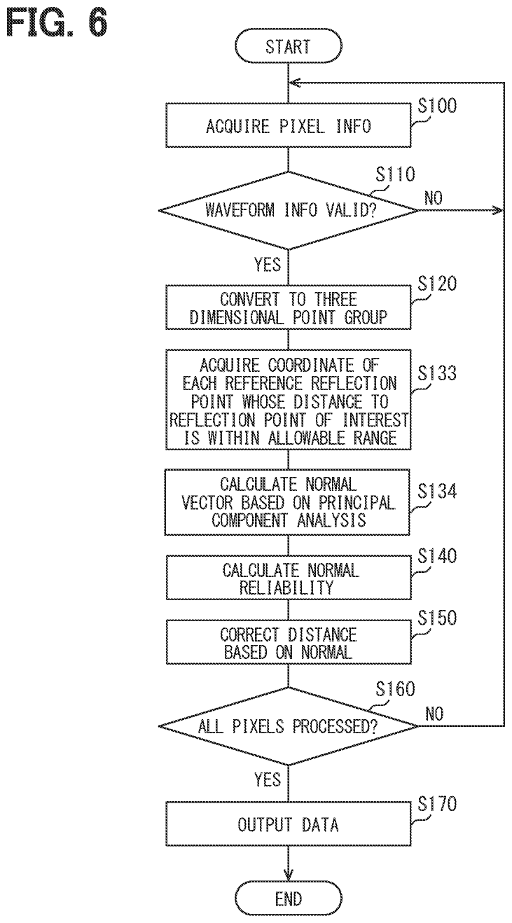

The following will describe a modification of the image processing device 100 according to the first embodiment as a second embodiment. In FIG. 5 and FIG. 6, the components denoted by the same reference symbols as those in the drawings of the first embodiment are equivalent to the components in the first embodiment, and provide similar operational effects.

In the second embodiment, as illustrated in FIG. 5, the normal calculation unit 130 selects, as the reference reflection points RPr, multiple reflection points that have inter-point distances from the reflection point of interest RPi being within an allowable range. The allowable range is a numerical range that is equal to or less than a threshold related to the distance to the reflection point of interest RPi or a numerical range that is less than the threshold. The normal calculation unit 130 excludes the reflection point of the adjacent pixel from the reference reflection point RPr when the distance based on the three-dimensional coordinates is out of the allowable range.

In the second embodiment, the normal calculation unit 130 executes principal component analysis based on the reference reflection points RPr and the reflection point of interest RPi. The normal calculation unit 130 calculates the normal vector Vn based on the result of the principal component analysis.

Detailed processing of normal vector calculation in the distance measurement correction method executed by the image processing device 100 of the second embodiment will be described below with reference to the flowchart of FIG. 6.

After S120, the flow proceeds to S133. In S133, the normal calculation unit 130 acquires coordinates of multiple reference reflection points RPr that have inter-point distances from the reflection point of interest RPi being within the allowable range. In S134, the normal calculation unit 130 calculates the normal vector Vn based on the principal component analysis of the point group including the focused reflection points of interest RPi and the reference reflection point RPr. After S134, the flow proceeds to S140.

According to the second embodiment described above, the normal direction of the reflection point of interest RPi is calculated based on the reflection point of interest RPi and multiple reference reflection points RPr that have the inter-point distances to the reflection point of interest RPi being within the allowable range. Thus, the normal direction can be easily calculated based on multiple reflection points on the same reflection object. As a result, the calculation accuracy of the normal direction can be improved.

### Third Embodiment

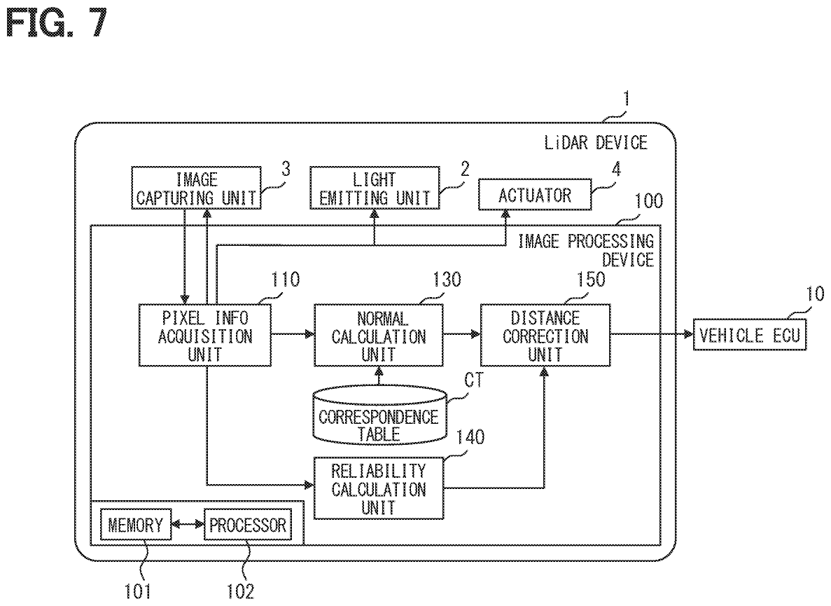

The following will describe a modification of the image processing device 100 according to the first embodiment as a third embodiment. In FIG. 7 to FIG. 9, the components denoted by the same reference symbols as those in the drawings of the first embodiment are equivalent components and have similar functions and effects.

In the third embodiment, the image processing device 100 is provided, in advance, with a correspondence table CT that stores a correspondence relationship between the detected waveform information and the normal for each pixel (see FIG. 7). Specifically, the correspondence table CT stores, in the memory 101, the magnitude of the inclination of the normal line corresponding to the detected waveform information for each reflection characteristic of the reflection object and the distance to the reflection object. The correspondence table CT stores the magnitude of the inclination of the normal line corresponding to the detected waveform information for each Lambertian reflection characteristic of the reflection object and distance to the reflection object. The detected waveform information stored in the correspondence table CT may be detected waveform information obtained by extracting feature points, or may be a complete detected waveform information.

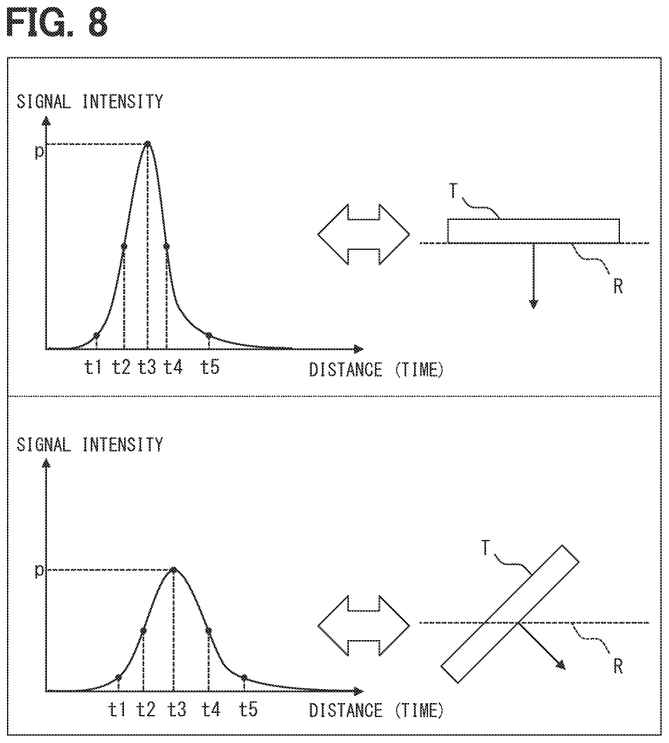

For example, the correspondence table CT stores at least one of the peak value, the pulse width, and the hem width of the waveform as the detected waveform information. The peak value is the maximum value of the signal intensity of the waveform (signal intensity p at t3 as illustrated in FIG. 8). The pulse width is a time width obtained as an absolute value of a difference between half-value points (see t2 and t4 in FIG. 8) at which the signal intensity becomes a half value of the peak value at the rising stage of and falling stage of the pulse. The hem width is a time width obtained as an absolute value of a difference between the pulse start time (see t1 in FIG. 8) and the pulse end time (see t5 in FIG. 8). The pulse start time is a time at which a difference between intensity of the background signal and intensity of the pulse signal is equal to or greater than a predetermined threshold value or exceeds the threshold value at the rising stage of the pulse. The background signal may be obtained by removing the pulse signal from the acquired signal. The background signal may include a signal derived from ambient light. Alternatively, the background signal may be a signal obtained by removing the pulse signal from the acquired signal from which the signal derived from ambient light has been removed. The pulse end time is a time at which a difference between intensity of the background signal and intensity of the pulse signal is equal to or lower than a predetermined threshold value or lower than the threshold value at the falling stage of the pulse.

For example, when the reflection characteristic and the distance are the same, the inclination of the normal direction with respect to the reference direction increases with an increase of the peak value. The inclination of the normal direction with respect to the reference direction increases with an increase of the pulse width. The inclination of the normal direction with respect to the reference direction increases with an increase of the hem width. The correspondence table CT stores such a relationship as a correspondence relationship between the detected waveform information and the normal. Parameters related with the magnitude of the inclination of the normal direction, such as the peak value, the pulse width, and the hem width may also be referred to as waveform feature amounts.

The normal calculation unit 130 calculates the inclination of the normal by comparing the reflection characteristic, the distance, and the detected waveform information at each reflection point with the correspondence table CT. That is, for the normal of a single reflection point, the normal calculation unit 130 calculates the inclination magnitude of the normal based on the information of the corresponding single pixel. When the reflection characteristic of the reflection point is unknown, the normal calculation unit 130 compares the distance and the detected waveform information with the correspondence table CT on the assumption that the reflection point has the Lambertian reflection characteristic.

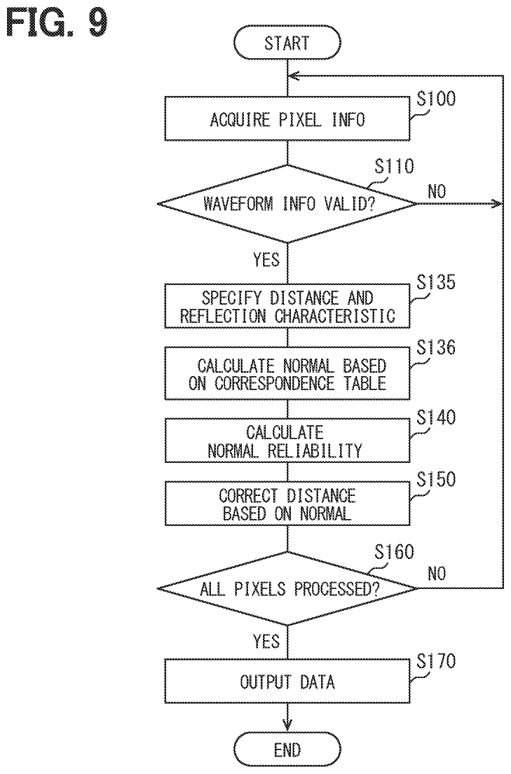

Detailed processing of normal vector calculation in the distance measurement correction method executed by the image processing device 100 of the third embodiment will be described below with reference to the flowchart of FIG. 9. Except for the detailed processing, the above description of the first embodiment is also applied to the present embodiment. First, in S135, the process acquires reflection characteristic of the reflection point of interest RPi and the distance to the reflection point of interest RPi. In S136, the inclination of the normal is calculated by comparing the reflection characteristic, the distance, and the detected waveform information of the reflection point of interest RPi with the correspondence table CT.

According to the third embodiment described above, the normal direction of the reflection point of interest RPi is calculated based on the detected waveform information acquired based on detection of the reflected light from the reflection point of interest RPi and the relationship information between the predetermined distance and the waveform of the reflected light. In this configuration, the normal direction of the reflection point of interest RPi is calculated based on the correspondence relationship. Thus, it is possible to reduce the calculation amount for specifying the normal direction thereby reducing calculation processing load. Further, it is possible to more accurately correct a distance to a reflection object, such as a distant object or a small object, for which it is difficult to detect reflection data across multiple pixels.

### Fourth Embodiment

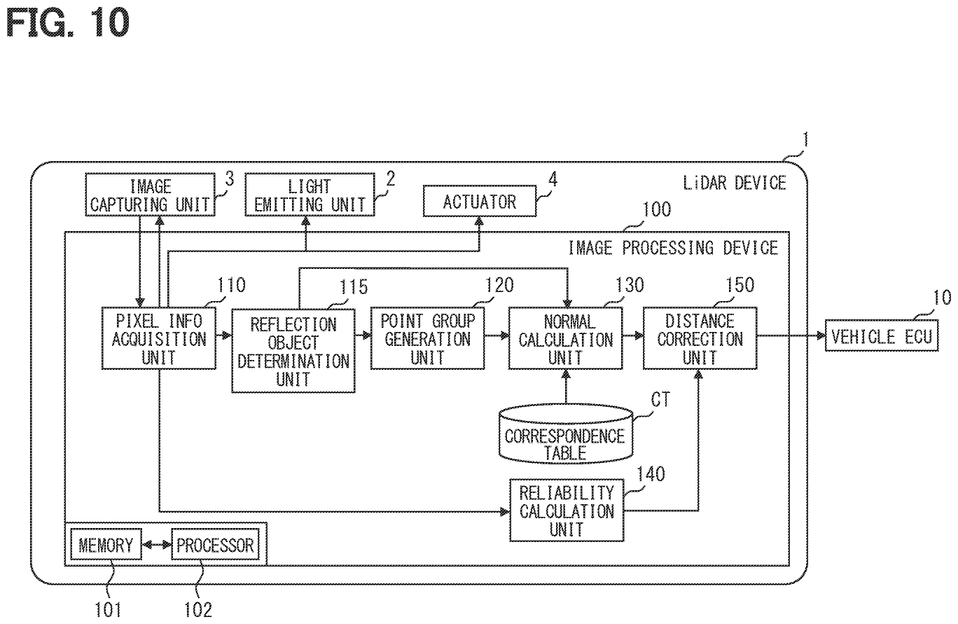

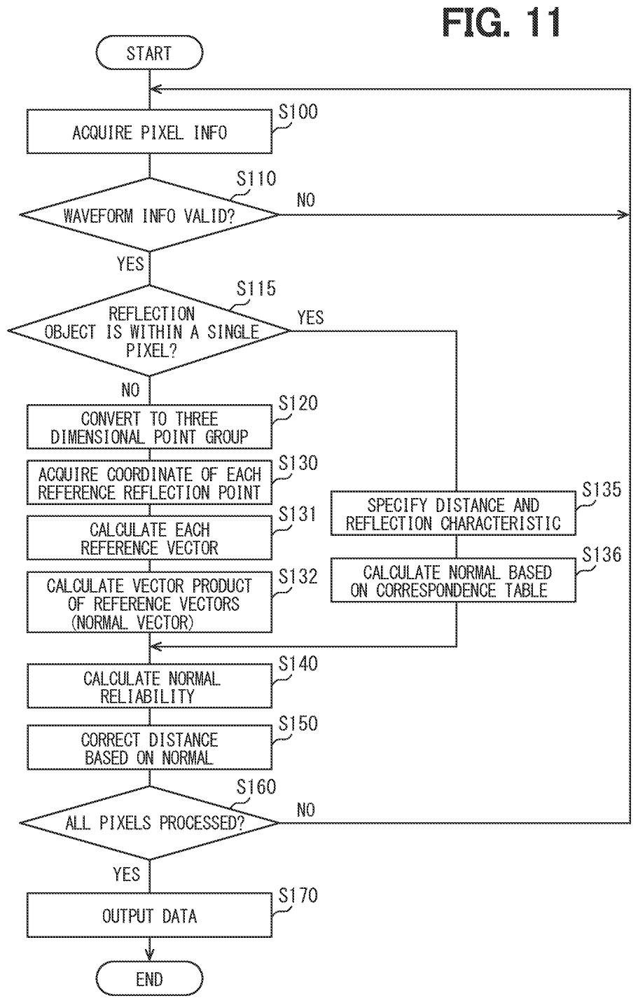

The following will describe a modification of the image processing device 100 according to the first embodiment as a fourth embodiment. In FIG. 10 and FIG. 11, components denoted by the same reference symbols as those in the drawings of the first embodiment are components equivalent to the first embodiment, and provide similar operational effects.

In the fourth embodiment, as illustrated in FIG. 10, the image processing device 100 includes a reflection object determination unit 115 as a functional unit. The reflection object determination unit 115 determines whether the reflected light information from the specific target T falls within a single pixel. Whether or not the reflected light information from the target T falls within a single pixel is a condition for switching the calculation method of the inclination feature amount of the reflection point of interest RPi. Therefore, the reflection object determination unit 115 corresponds to a condition determination unit that determines whether the condition is satisfied or not.

The normal calculation unit 130 changes the calculation method of the normal for each pixel based on the determination result. Specifically, the normal calculation unit 130 switches between calculation of the normal vector Vn based on the multiple pixel information and calculation of the normal vector Vn based on the single pixel information according to the type of the reflection object.

More specifically, when the reflected light information from the specific reflection object falls within a single pixel, the normal calculation unit 130 calculates the normal vector Vn based on the single pixel information. When the reflected light information from the specific reflection object is detected over multiple pixels, the normal calculation unit 130 calculates the normal vector Vn based on the multiple pixel information.

The following will describe a distance measurement correction method executed by the image processing device 100 in cooperation with the functional blocks with reference to FIG. 11.

When an affirmative determination is made in S110, the flow proceeds to S115. In S115, the reflection object determination unit 115 determines whether the reflection object is included in a single pixel. When determining that the reflection object is not included in a single pixel, the normal calculation unit 130 calculates the normal vector Vn based on the multiple pixel information in S130, S131, and S132. When determining that the reflection object is included in a single pixel, the normal calculation unit 130 calculates the normal vector Vn based on the single pixel information in S135 and S136.

According to the fourth embodiment described above, the normal vector Vn is calculated based on single pixel information for a reflection object that is far enough or small enough such that the reflected light information falls within a single pixel. The normal vector Vn is calculated based on the multiple pixel information for a reflection object that is close enough or large enough such that the reflected light information covers multiple pixels.

### Fifth Embodiment

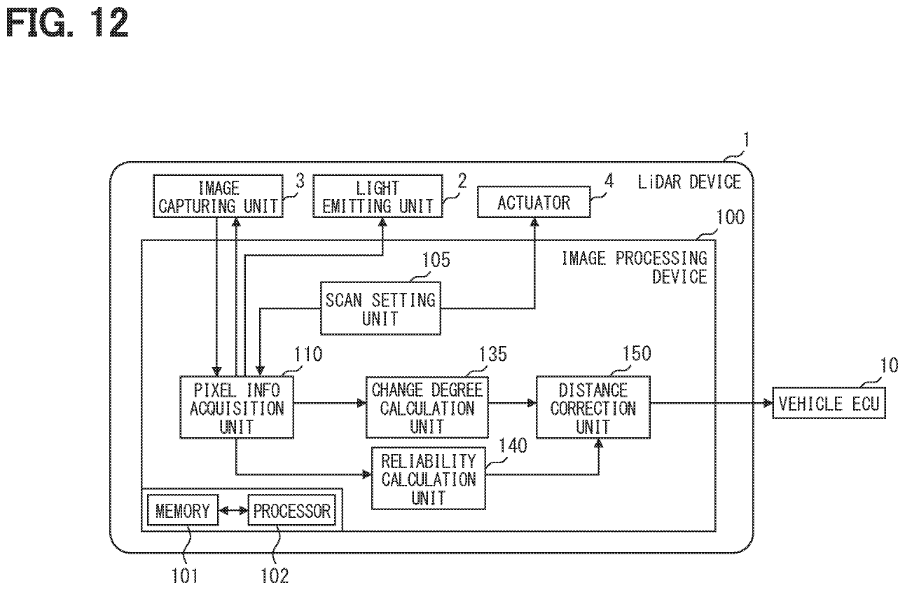

The following will describe a modification of the image processing device 100 according to the third embodiment as a fifth embodiment. In FIG. 12 to FIG. 14, the components denoted by the same reference symbols as those in the drawings of the first embodiment are equivalent components and have similar operational effects.

Specifically, as illustrated in FIG. 12, the image processing device 100 includes, as functional units, a scan setting unit 105, a pixel information acquisition unit 110, a change degree calculation unit 135, a reliability calculation unit 140, and a distance correction unit 150.

The scan setting unit 105 sets a scan speed of the laser beam by the actuator 4. The scan setting unit 105 sets different scan speeds for a first scan cycle and a second scan cycle. In the first scan cycle, scanning is performed at a predetermined scan speed. In the second scan cycle, scanning is performed at a scan speed faster or slower than that of the first scan cycle. For example, the scan setting unit 105 sets the first scan cycle and the second scan cycle to be alternately repeated, thereby executing scanning for multiple cycles. Alternatively, the scan setting unit 105 may set the scanning by repeating a scanning pattern in which the first scan cycle is repeatedly performed by multiple times and subsequently the second scan cycle is repeatedly performed by multiple times.

The change degree calculation unit 135 calculates a degree of change in the shape of each detected waveform for each scan speed, which is acquired by detecting reflected light from the same reflection point scanned at different scan speeds. Specifically, the change degree calculation unit 135 calculates the degree of change of the waveforms detected in the first scan cycle and the second scan cycle. The change degree calculation unit 135 calculates, for example, a difference between the waveform feature amounts detected in the first scan cycle and the second scan cycle as the change degree. The waveform feature amount may include at least one of a peak value, a pulse width, and a hem width. The change degree may be an evaluation value of the magnitude of change obtained by integrating multiple feature amounts. The change degree is an example of an inclination feature amount.

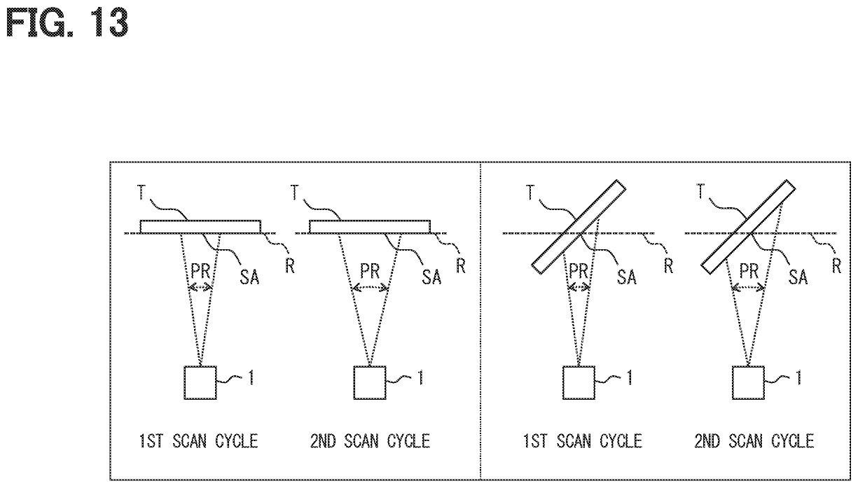

The distance correction unit 150 corrects the distance corresponding to a magnitude of the change degree. Specifically, as illustrated in FIG. 13, when the inclination of the partial surface SA with respect to the reference surface R is large, the shape change of the waveform is larger than that when the inclination is relatively small. Specifically, with an increase of the inclination, as the shape change of the waveform, the peak value decreases, the pulse width increases, and the hem width increases. According to this reason, as the change degree increases, the deviation of the distance from the true distance value increases. Thus, the distance correction unit 150 increases the correction value as the change degree increases.

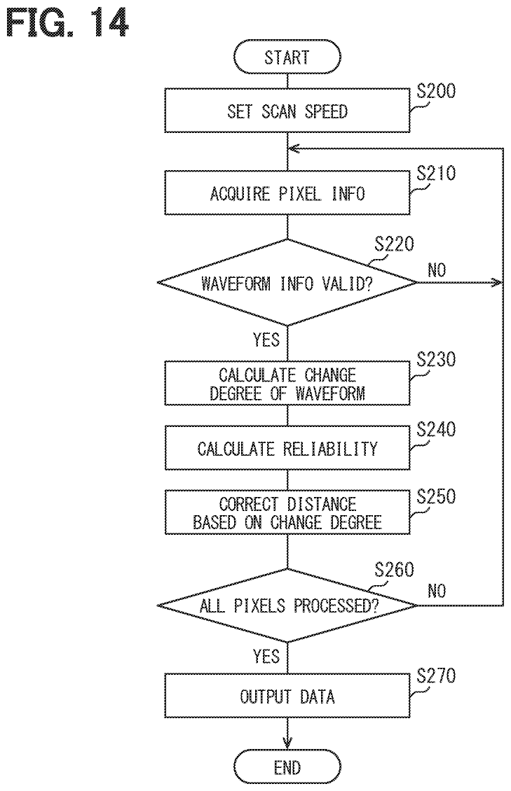

The following will describe a distance measurement correction method executed by the image processing device 100 in cooperation with the functional blocks with reference to FIG. 14.

In S200, the scan setting unit 105 sets the scan speeds to be different between the first scan cycle and the second scan cycle. In S210, the pixel information acquisition unit 110 acquires the pixel information of the reflection point of interest RPi based on the setting by the scan setting unit. At this time, the pixel information acquisition unit 110 acquires both the pixel information in the first scan cycle and the pixel information in the second scan cycle. The process executed in S220 is similar to that executed in S110 described above.

When an affirmative determination is made in S220, the flow proceeds to S230. In S230, the change degree calculation unit 135 calculates the change degree of the waveform for each cycle. In subsequent S240, the reliability calculation unit 140 calculates the reliability of the detected waveform. The reliability of the detected waveform may be calculated based on the signal intensity, the ambient light intensity, and the like. In S250, the distance correction unit 150 performs distance correction based on the change degree of the waveform and the reliability. The process executed in S260 and 270 are similar to that executed in S160 and S170 described above. The process executed in S210 and S220 corresponds to an example of an acquisition process. The process executed in S230 corresponds to an example of a feature amount calculation process. The process executed in S250, S260, and S270 corresponds to an example of a correction process.

### Sixth Embodiment

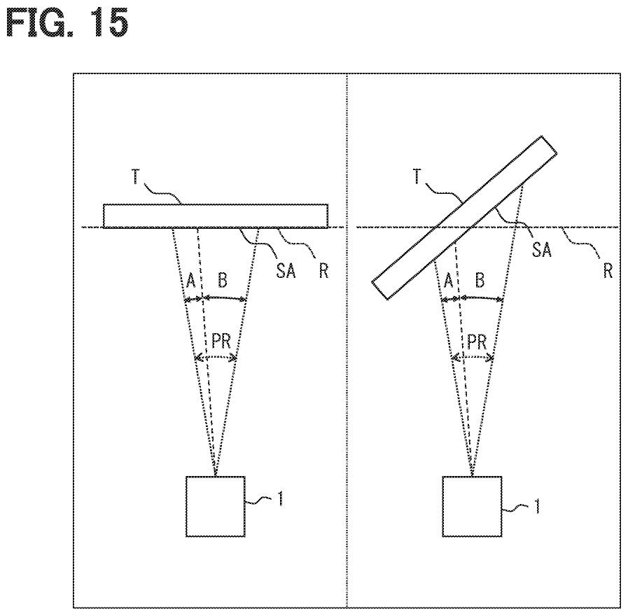

The following will describe a modification of the image processing device 100 according to the fifth embodiment as a sixth embodiment. In the sixth embodiment, the scan setting unit 105 changes the scan speed within the detection range PR corresponding to one pixel. Specifically, in the detection range PR corresponding to one pixel, as illustrated in FIG. 15, the scan setting unit 105 sets multiple ranges in which the scan speeds are different from one another. For example, in a high speed range A, the scan speed may be set to high speed, and in a low speed range B, the scan speed may be set to be lower than the speed within the high speed range A.

The pixel information acquisition unit 110 acquires pixel information for each sub-pixel obtained by dividing one pixel into the high speed range A and the low speed range B.

The scan speed is changed within the detection range PR corresponding to one pixel. The pixel corresponding to the reflection point is divided into multiple sub-pixels corresponding to the different scan speeds. The degree change calculation unit 135 detects the reflected light corresponding to each sub-pixel, and calculates change degree of shape for the reflected lights from multiple sub-pixels. Specifically, the change degree calculation unit 135 calculates the change degree between the detected waveform in the high speed range A and the detected waveform in the low speed range B as the inclination feature amount. The change degree calculation unit 135 may use, as the change degree, the change amount of at least one or more waveform characteristics. The change degree calculation unit 135 may use, as the change degree, the change amount based on all points of the detected waveform. This change degree is an example of the inclination feature amount.

The distance correction unit 150 corrects the distance detected for the corresponding pixel in accordance with the magnitude of the change degree. When the inclination of the reflection surface with respect to the reference surface R is large, the shape change of the waveform detected in each of the ranges A and B is larger, compared with a case where the inclination of the reflection surface with respect to the reference surface R is relatively small. Specifically, with an increase of the inclination, as the shape change of the waveform, the peak value decreases, the pulse width increases, and the hem width increases. According to this reason, as the change degree increases, the deviation of the distance from the true distance value increases. Thus, the distance correction unit 150 increases the correction value as the change degree increases.

In the distance measurement correction method according to the sixth embodiment, in S200, the scan setting unit 105 sets multiple ranges in which the scan speeds are different from one another. Specifically, in the high speed range A, the scan speed is set to high speed, and in the low speed range B, the scan speed is set to be lower than the speed within the high speed range A. In S210, the pixel information acquisition unit 110 acquires the pixel information of the reflection point of interest RPi based on the setting by the scan setting unit. The pixel information acquisition unit 110 acquires pixel information for each sub-pixel obtained by dividing one pixel into the high speed range A and the low speed range B. In S230, the change degree calculation unit 135 calculates the change degree of the waveform for each sub-pixel.

### Other Embodiments

The present disclosure is not limited to the above-described embodiments. The present disclosure includes embodiments described above and modifications of the above-described embodiments made by a person skilled in the art. For example, the disclosure is not limited to components and/or combinations of elements presented in the embodiments provided herein. The present disclosure may be implemented in various combinations thereof. The disclosure may have additional components that can be added to the embodiments. The present disclosure also includes modifications which include partial components/elements of the above-described embodiments. The present disclosure includes replacements of components and/or elements between one embodiment and another embodiment, or combinations of components and/or elements between one embodiment and another embodiment The disclosed technical scope is not limited to the description of the embodiments. It should be understood that some disclosed technical scope are indicated by description of claims, and includes every modification within the equivalent scope and the scope of description of claims.

In the above-described embodiment, the dedicated computer constituting the image processing device 100 is provided by an electronic control unit (ECU) constituting the LiDAR device 1. Alternatively, the dedicated computer constituting the image processing device 100 may be provided by a driving control ECU mounted on the vehicle or an actuator ECU mounted on the vehicle. Alternatively, the dedicated computer constituting the image processing device 100 may be a locator ECU or a navigation ECU. Alternatively, the dedicated computer constituting the image processing device 100 may be an HMI control unit (HCU).

In the second embodiment described above, the normal calculation unit 130 calculates the normal vector Vn based on the principal component analysis. Alternatively, the normal calculation unit may calculate the normal vector Vn as the outer product of the reference vectors Vr similar to the first embodiment.

In the above-described third embodiment, the normal calculation unit 130 calculates the normal direction based on the correspondence table CT in which the inclination magnitude of the normal corresponding to the detected waveform information is stored for each of the reflection characteristic of the reflection object and the distance to the reflection object. Alternatively, the normal calculation unit 130 may calculate the normal direction based on a function representing the correspondence relationship.

In the fifth embodiment and the sixth embodiment, which corresponds to the modification examples, the change degree calculation unit 135 may further calculate the normal direction based on the change degree of the waveform. In this case, the distance correction unit 150 may execute the distance correction based on the normal direction.

The image processing device 100 may be a special purpose computer configured to include at least one of a digital circuit and an analog circuit as a processor. In particular, the digital circuit may include at least one of an application specific integrated circuit (ASIC), a field programmable gate array (FPGA), a system on a chip (SOC), a programmable gate array (PGA), a complex programmable logic device (CPLD), and the like. Such a digital circuit may include a memory in which a program is stored.

The image processing device 100 may be provided by a single computer or a set of computer resources linked by a data communication device. For example, some of the functions provided by the image processing device in the above-described embodiment may be implemented by another ECU.

What is claimed is:

1. A distance measurement correction device, which corrects a distance measurement result output from a distance measurement device, the distance measurement device measuring a distance to a reflection point on a target by detecting, as a pixel, light reflected on the reflection point in response to irradiation of the light, the distance measurement correction device comprising a processor that is configured to:
for each of a plurality of reflection points, acquire relevant information, which is information related to a distance detected with respect to a pixel corresponding to each of the plurality of reflection points;
calculate an inclination feature amount related to an inclination magnitude of each of a plurality of partial surfaces of the target relative to a reference surface, the plurality of partial surfaces of the target including the plurality of reflection points, respectively; and
correct the distance to each of the plurality of reflection points based on the corresponding inclination feature amount.

2. The distance measurement correction device according to claim 1, wherein
the processor calculates, as the inclination feature amount, a normal direction of each of the plurality of reflection points.

3. The distance measurement correction device according to claim 2, wherein
the plurality of reflection points include a reflection point of interest for which the normal direction is to be calculated and multiple reference reflection points other than the reflection point of interest, and
the processor calculates, for each of the plurality of reflection points, the normal direction based on three-dimensional position information of the reflection point of interest and the multiple reference reflection points.

4. The distance measurement correction device according to claim 3, wherein
the processor extracts the multiple reference reflection points under a condition that an inter-point distance between the reflection point of interest and each of the multiple reference reflection points is within an allowable range, and
the processor calculates the normal direction of the reflection point of interest based on the reflection point of interest and the multiple reference reflection points.

5. The distance measurement correction device according to claim 2, wherein
the processor calculates, for each of the plurality of reflection points, the normal direction based on (i) detected waveform information acquired by detecting the light reflected on the corresponding reflection point and (ii) preliminarily defined information indicating a relationship between the distance and a waveform of light reflected on the corresponding reflection point.

6. The distance measurement correction device according to claim 3, wherein
the processor determines a correction amount of the distance based on an inclination magnitude of the normal direction at the reflection point of interest relative to a line-of-sight direction of the pixel corresponding to the reflection point of interest.

7. The distance measurement correction device according to claim 2, further comprising
an actuator that scans the target by irradiating the light,
wherein
the processor calculates, as the inclination feature amount, the normal direction of each of the plurality of reflection points based on a change degree in shapes of detected waveforms corresponding to different scan speeds, and
the detected waveforms are generated by detecting lights reflected on one of the plurality of reflection points when the one of the plurality of reflection points is scanned by the different scan speeds.

8. The distance measurement correction device according to claim 2, further comprising
an actuator that scans the target by irradiating the light,
wherein
the processor calculates, as the inclination feature amount, the normal direction of each of the plurality of reflection points based on a change degree in shapes of detected waveforms corresponding to multiple sub pixels,
the detected waveforms are generated by detecting lights reflected on one of the plurality of reflection points when a scan speed is changed during the one of the plurality of reflection points being scanned, and
the pixel corresponding to the one of the plurality of reflection points is divided into the multiple sub pixels corresponding to the scan speed.

9. The distance measurement correction device according to claim 2, wherein
the processor increases a correction amount of the distance with an increase of a calculation reliability of the normal direction.

10. The distance measurement correction device according to claim 2, wherein
the processor increases a correction amount of the distance with an increase of the distance to the corresponding reflection point before correction.

11. The distance measurement correction device according to claim 1, further comprising
an actuator that scans the target by irradiating the light,
wherein
the processor calculates, as the inclination feature amount, a change degree in shapes of detected waveforms corresponding to different scan speeds, and
the detected waveforms are generated by detecting lights reflected on one of the plurality of reflection points when the one of the plurality of reflection points is scanned by the different scan speeds.

12. The distance measurement correction device according to claim 1, further comprising
an actuator that scans the target by irradiating the light,
wherein
the processor calculates, as the inclination feature amount, a change degree in shapes of detected waveforms corresponding to multiple sub pixels,
the detected waveforms are generated by detecting lights reflected on one of the plurality of reflection points when a scan speed is changed during the one of the plurality of reflection points being scanned, and
the pixel corresponding to the one of the plurality of reflection points is divided into the multiple sub pixels corresponding to the scan speed.

13. A distance measurement correction method, which corrects a distance measurement result output from a distance measurement device, the distance measurement device measuring a distance to a reflection point on a target by detecting, as a pixel, light reflected on the reflection point in response to irradiation of the light, the distance measurement correction method being executed by a processor and comprising:
for each of a plurality of reflection points, acquiring relevant information, which is information related to a distance detected with respect to a pixel corresponding to each of the plurality of reflection points;
calculating an inclination feature amount related to an inclination magnitude of each of a plurality of partial surfaces of the target relative to a reference surface, the plurality of partial surfaces of the target including the plurality of reflection points, respectively; and
correcting the distance to each of the plurality of reflection points based on the corresponding inclination feature amount.

14. The distance measurement correction method according to claim 13, further comprising
calculating, as the inclination feature amount, a normal direction of each of the plurality of reflection points.

15. The distance measurement correction method according to claim 14, wherein
the plurality of reflection points include a reflection point of interest for which the normal direction is to be calculated and multiple reference reflection points other than the reflection point of interest, and
the method further comprises calculating, for each of the plurality of reflection points, the normal direction based on three-dimensional position information of the reflection point of interest and the multiple reference reflection points.

16. The distance measurement correction method according to claim 15, further comprising
extracting the multiple reference reflection points under a condition that an inter-point distance between the reflection point of interest and each of the multiple reference reflection points is within an allowable range, and
calculating the normal direction of the reflection point of interest based on the reflection point of interest and the multiple reference reflection points.

17. The distance measurement correction method according to claim 14, further comprising
calculating, for each of the plurality of reflection points, the normal direction based on (i) detected waveform information acquired by detecting the light reflected on the corresponding reflection point and (ii) preliminarily defined information indicating a relationship between the distance and a waveform of light reflected on the corresponding reflection point.

18. The distance measurement correction method according to claim 15, further comprising
determining a correction amount of the distance based on an inclination magnitude of the normal direction at the reflection point of interest relative to a line-of-sight direction of the pixel corresponding to the reflection point of interest.

19. The distance measurement correction method according to claim 14, wherein
the distance measurement device includes an actuator that scans the target by irradiating the light,
the distance measurement correction method further comprises calculating, as the inclination feature amount, the normal direction of each of the plurality of reflection points based on a change degree in shapes of detected waveforms corresponding to different scan speeds, and
the detected waveforms are generated by detecting lights reflected on one of the plurality of reflection points when the one of the plurality of reflection points is scanned by the different scan speeds.

20. The distance measurement correction method according to claim 14, wherein
the distance measurement device includes an actuator that scans the target by irradiating the light,
the distance measurement correction method further comprises calculating, as the inclination feature amount, the normal direction of each of the plurality of reflection points based on a change degree in shapes of detected waveforms corresponding to multiple sub pixels,
the detected waveforms are generated by detecting lights reflected on one of the plurality of reflection points when a scan speed is changed during the one of the plurality of reflection points being scanned, and
the pixel corresponding to the one of the plurality of reflection points is divided into the multiple sub pixels corresponding to the scan speed.

21. The distance measurement correction method according to claim 14, further comprising
increasing a correction amount of the distance with an increase of a calculation reliability of the normal direction.

22. The distance measurement correction method according to claim 14, further comprising
increasing a correction amount of the distance with an increase of the distance to the corresponding reflection point before correction.

23. The distance measurement correction method according to claim 13, wherein
the distance measurement device includes an actuator that scans the target by irradiating the light,
the distance measurement correction method further comprises calculating, as the inclination feature amount, a change degree in shapes of detected waveforms corresponding to different scan speeds, and
the detected waveforms are generated by detecting lights reflected on one of the plurality of reflection points when the one of the plurality of reflection points is scanned by the different scan speeds.

24. The distance measurement correction method according to claim 13, wherein
the distance measurement device includes an actuator that scans the target by irradiating the light,
the distance measurement correction method further comprises calculating, as the inclination feature amount, a change degree in shapes of detected waveforms corresponding to multiple sub pixels,
the detected waveforms are generated by detecting lights reflected on one of the plurality of reflection points when a scan speed is changed during the one of the plurality of reflection points being scanned, and
the pixel corresponding to the one of the plurality of reflection points is divided into the multiple sub pixels corresponding to the scan speed.

25. A computer-readable non-transitory storage medium storing a program, the program comprising instructions to be executed by a processor to correct a distance measurement result output from a distance measurement device, the distance measurement device measuring a distance to a reflection point on a target by detecting, as a pixel, light reflected on the reflection point in response to irradiation of the light,
the instructions comprising:
for each of a plurality of reflection points, acquiring relevant information, which is information related to a distance detected with respect to a pixel corresponding to each of the plurality of reflection points;
calculating an inclination feature amount related to an inclination magnitude of each of a plurality of partial surfaces of the target relative to a reference surface, the plurality of partial surfaces of the target including the plurality of reflection points, respectively; and
correcting the distance to each of the plurality of reflection points based on the corresponding inclination feature amount.

26. A distance measurement device, which measures a distance to a reflection point on a target by detecting, as a pixel, light reflected on the reflection point in response to irradiation of the light, the distance measurement device comprising a processor configured to:
for each of a plurality of reflection points, acquire relevant information, which is information related to a distance detected with respect to a pixel corresponding to each of the plurality of reflection points;
calculate an inclination feature amount related to an inclination magnitude of each of a plurality of partial surfaces of the target relative to a reference surface, the plurality of partial surfaces of the target including the plurality of reflection points, respectively; and
correct the distance to each of the plurality of reflection points based on the corresponding inclination feature amount.
